(19) United States
(12) Patent Application Publication
(10) Pub. No.: US 2011/0179444 A1
(43) Pub. Date: Jul. 21, 2011

(54) APPARATUS AND METHOD FOR DOWNLOADING CONDITIONAL ACCESS IMAGES

(75) Inventors: Jin-Young MOON, Daejeon (KR); Jong-Youl PARK, Daejeon (KR); Eui-Hyun PAIK, Daejeon (KR); Dong-Won HAN, Daejeon (KR)

(73) Assignee: Electronics and Telecommunications Research Institute, Daejeon-city (KR)

(21) Appl. No.: 13/009,429

(22) Filed: Jan. 19, 2011

(30) Foreign Application Priority Data
Jan. 19, 2010 (KR) 10-2010-0004843
Aug. 25, 2010 (KR) 10-2010-0082551

(51) Int. Cl. H04N 7/167

(52) U.S. Cl. 725/31

(57) ABSTRACT

Disclosed herein is a software-based conditional access image download client device. The software-based conditional access image download client device includes a download management module, a conditional access image splitter, and a conditional access image restoration unit. The download management module establishes a secure channel for communicating with a download server device over a network, and communicates with the download server device in compliance with a download protocol. The conditional access image splitter splits a conditional access image, received via the download management module, into a plurality of files, generates a plurality of encrypted files by encrypting the plurality of files, and stores the plurality of encrypted files. The conditional access image restoration unit restores the plurality of encrypted files to the conditional access image when the conditional access image is required.

### CROSS REFERENCE TO RELATED APPLICATIONS

This application claims the benefit of Korean Patent Application No. 10-2010-0004843, filed on Jan. 19, 2010, and Korean Patent Application No. 10-2010-0082551, filed on Aug. 25, 2010, which are hereby incorporated by reference in their entirety into this application.

### BACKGROUND OF THE INVENTION

1. Field of the Invention

The present invention relates generally to an apparatus and method for downloading conditional access images, which is capable of safely downloading conditional access images in a software-based Internet Protocol Television (IPTV) Conditional Access System (CAS), and, more particularly, to an apparatus and method for downloading conditional access images, which can enhance the security of a software-based CAS.

2. Description of the Related Art

In general, a CAS is a content security solution which enables only authorized subscribers to view corresponding channels in a paid TV system. That is, a CAS grants an authority to view a paid broadcast. A CAS is a technology that is configured to encrypt broadcast content, to send the encrypted broadcast content to recipients via cable, satellite, terrestrial waves or the Internet, and to grant authority to decrypt the encrypted broadcast content only to recipients who paid dues (i.e., subscription fees), thereby enabling “paid services.”

In a CAS, a head end scrambles content and then sends the scrambled content in order to prevent unauthorized recipients from accessing the CAS. Receivers receive the scrambled content from the head end, and restore it using a descrambling process. Here, most of CASs uses the same keys for the scrambling and descrambling keys. These keys are called control words. A conditional access server encrypts a control word, used in the scrambling, using another key and then sends it to receivers using an authority control message in order to safely send the control word. The head end sends the control word used in a scrambler so that the receiver can acquire the key used to scramble the control word. The head end encrypts the control word using an authentication key to realize security, and then sends it using an authority restriction message.

FIG. 1 is a block diagram illustrating the configuration of a conventional hardware-based CAS. As shown in FIG. 1, the conventional hardware-based CAS includes a scrambling/descrambling part 30 and a key encryption/decryption part 40. In the scrambling/descrambling part 30, the scrambler of a head end 10 scrambles content, and the descrambler of a receiver 20 descrambles the content. In the key encryption/decryption part 40, the conditional access server of the head end 10 encrypts a control word used for the scrambling/descrambling of content and then sends the encrypted control word, and the key management module of the receiver 20 decrypts the encrypted control word and then provides the decrypted control word to the descrambler. In this conventional hardware-based CAS, the key encryption/decryption part 40, or the key encryption/decryption part 40 and the descrambler is or are mounted on a replaceable hardware device, such as a smart card, or a terminal in the form of an embedded system, thereby making it difficult to replace the key encryption/decryption part 40 or the key encryption/decryption part 40 and the descrambler. That is, the conventional hardware-based CAS is problematic in that the key encryption/decryption part 40 can be changed only when the replaceable smart card or hardware installed in the receiver 20 is replaced.

In a software-based CAS which was developed in order to solve the above-described problem, a key management module for processing an authority control message and an authority management message is created in the form of a conditional access image so that a receiver acquires a control word, the conditional access image is downloaded from a head end, the downloaded conditional access image is objectified using a loader, and the objectified image is used to receive and acquire the control word using conditional access messages as input. Since the software-based IPTV CAS enables conditional access images to be safely downloaded using an IP network, the functionality of dynamically updating the conditional access images can improve the safety of the software-based CAS.

However, the software-based CAS is problematic in that it has lower safety than does hardware-based CAS. That is, the software-based CAS is problematic in that it is vulnerable to external hacking because data, such as a control word and an authentication key, is transmitted over an IP network.

Furthermore, the software-based CAS is problematic in that there is the danger of hacking because conditional access images are decrypted and then stored on the hard disk of a terminal when being downloaded over the IP network or after downloading.

Furthermore, the software-based CAS is problematic in that conditional access images may be used to produce a copy terminal by copying the hard disk because the conditional access images are stored on the hard disk without having been changed.

### SUMMARY OF THE INVENTION

Accordingly, the present invention has been made keeping in mind the above problems occurring in the prior art, and an object of the present invention is to provide an apparatus and method for downloading conditional access images, which enables a conditional access image to be safely downloaded over an IP network, enables the downloaded conditional access image to be safely stored on a terminal so as to prevent it from being leaked by the copying of a hard disk, and enables the stored conditional access image to be restored to an available form when necessary.

In order to achieve the above object, the present invention provides a software-based conditional access image download client device, including a download management module for establishing a secure channel for communicating with a download server device over a network, and communicating with the download server device in compliance with a download protocol; a conditional access image splitter for splitting a conditional access image, received via the download management module, into a plurality of files, generating a plurality of encrypted files by encrypting the plurality of files, and storing the plurality of encrypted files; and a conditional access image restoration unit for restoring the plurality of encrypted files to the conditional access image when the conditional access image is required.

The software-based conditional access image download client device may further include an encryption module for encrypting communication messages, which are used when communicating with the download server device, using a download key.

The conditional access image splitter may generate encryption metadata when the conditional access image is split and encrypted.

The encryption metadata includes the number of times that the conditional access image is split, encryption algorithms and encryption keys for the split files, and information about storage of the encrypted files.

The encryption metadata generated by the conditional access image splitter may be encrypted and stored using a download key.

The conditional access image restoration unit may restore to the conditional access image by decrypting and merging the plurality of encrypted files using encryption metadata which is generated when the conditional access image is split and encrypted.

The conditional access image restoration unit may delete the restored conditional access image after the restored conditional access image has been used.

Additional, in order to achieve the above object, the present invention provides a software-based conditional access image download server device, including a download management module for establishing a secure channel for communicating with a download client device over a network, and communicating with the download client device in compliance with a download protocol; a conditional access image management module for generating a conditional access image using a key management module necessary to acquire a control word; and an encryption module for generating an encrypted communication message by encrypting a communication message, which will be sent to the download client device in compliance with the download protocol and includes the conditional access image, using a download key.

The network may be an IP-based network.

The conditional access image may be split and managed by the download client device.

The download management module may execute a Secure Socket Layer (SSL)-based download protocol along with the download client device.

Additional, in order to achieve the above object, the present invention provides a software-based conditional access image download method, including establishing a secure communication channel with a download server device over a network and communicating with the download server device in compliance with a download protocol; splitting a conditional access image, downloaded from the download server device, into a plurality of files, generating a plurality of encrypted files by encrypting the plurality of split files, and storing the plurality of encrypted files; and restoring the conditional access image from the plurality of encrypted files.

The communicating with the download server device comprises executing an SSL-based download protocol over an IP-based network.

The conditional access image is generated using a key management module for acquiring a control word.

The communicating with the download server device comprises encrypting a communication message, used when communicating with the download server device in order to download the conditional access image, using a download key and sending the encrypted communication message.

The storing the plurality of encrypted files comprises encrypting each of the plurality of files using a download key.

The software-based conditional access image download method may further include deleting the restored conditional access image after using the restored conditional access image.

The software-based conditional access image download method may further include generating encryption metadata, including a number of times that the conditional access image is divided, encryption algorithms and encryption keys for the split files, and information about storage of the plurality of encrypted files based on the merging and encryption of the conditional access image.

The encryption metadata is encrypted and stored using one of a download key and an encryption key.

The restoring the conditional access image comprises restoring the plurality of encrypted files to the conditional access image by decrypting the plurality of encrypted files using encryption metadata generated when the plurality of encrypted files are stored and merging the decrypted files into the conditional access image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a conventional hardware-based CAS;

FIG. 2 is a diagram illustrating an apparatus for downloading conditional access images according to an embodiment of the present invention;

FIG. 3 is a block diagram illustrating the download server device of FIG. 2;

FIG. 4 is a diagram illustrating the communication protocol of the download server device and the download client device of FIG. 2;

FIGS. 5 to 8 are diagrams illustrating the download client device of FIG. 2;

FIG. 9 is a flowchart illustrating a method of downloading conditional access images according to an embodiment of the present invention; and

FIG. 10 is a flowchart illustrating the steps of storing and using a conditional access image of FIG. 9.

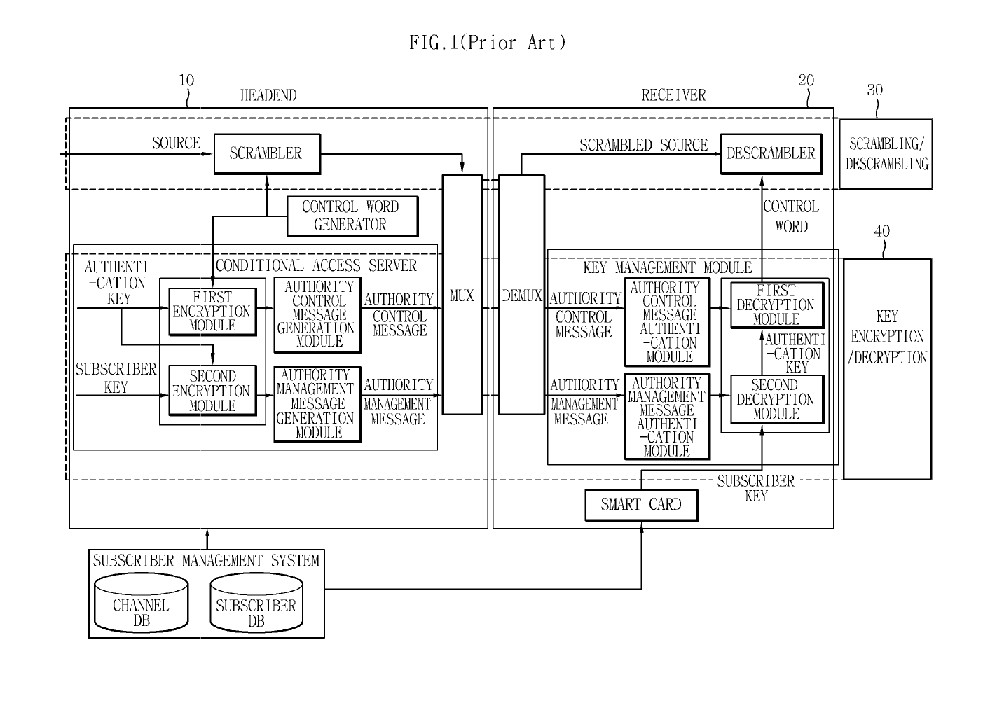

### DESCRIPTION OF THE PREFERRED EMBODIMENTS

Some embodiments of the present invention will now be described in detail with reference to the accompanying drawings in order for those skilled in the art to be able to readily practice them. It is to be noted that with regard to the assignment of reference numerals to the elements of the drawings, the same reference numerals designate the same elements even when the elements are shown in different drawings. Furthermore, in the following description of the present invention, detailed descriptions of the known functions and constructions will be omitted if it is deemed they would make the gist of the present invention unnecessarily vague.

An apparatus for downloading conditional access images according to an embodiment of the present invention will be described in detail below with reference to the accompanying drawings.

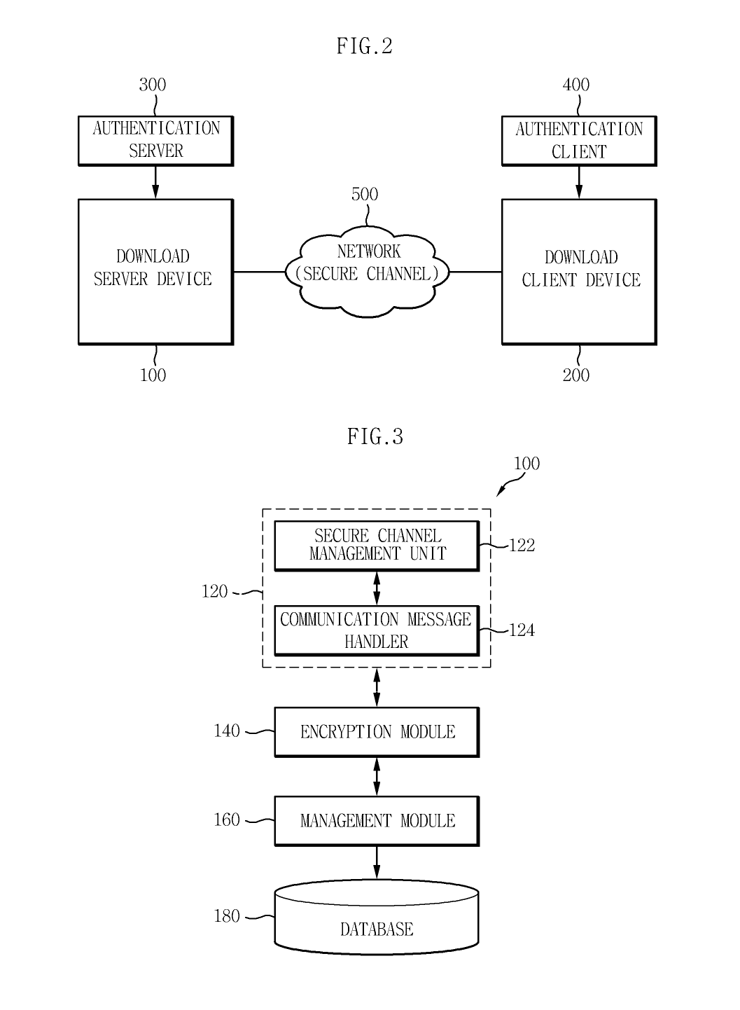

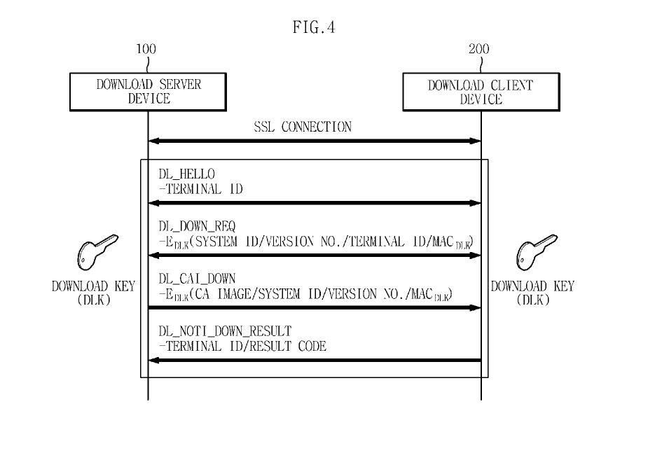

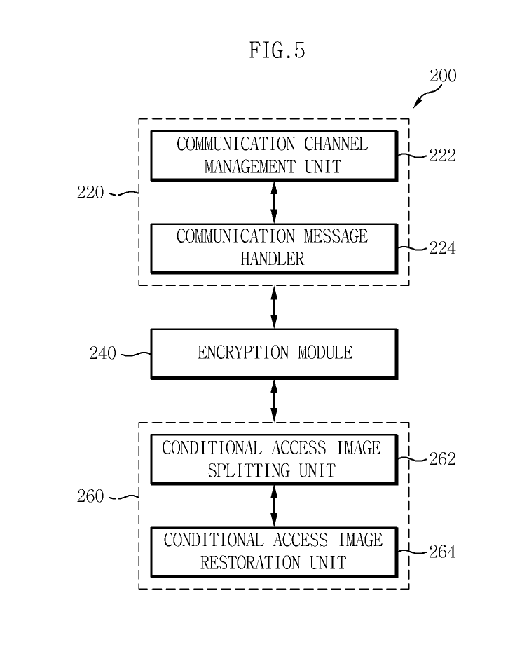

FIG. 2 is a diagram illustrating an apparatus for downloading conditional access images according to an embodiment of the present invention, FIG. 3 is a block diagram illustrating the download server device of FIG. 2, FIG. 4 is a diagram illustrating the communication protocol of the download server device and the download client device of FIG. 2, and FIGS. 5 to 8 are diagrams illustrating the download client device of FIG. 2.

As shown in FIG. 2, the apparatus for downloading conditional access images includes a download server device 100 and a download client device 200.

The download server device 100 is connected to an authentication server 300 for providing a download key (DLK) used to encrypt communication messages and a conditional access image. The download client device 200 is connected to an authentication client 400 for providing the DLK used to encrypt the communication messages and the conditional access image.

The download server device 100 and the download client device 200 are connected to each other over a network 500 (i.e., an IP network). The download server device 100 and the download client device 200 send and receive the conditional access image in compliance with a Secure Socket Layer (SSL)-based download protocol (i.e., using a communication message encrypted using a DLK, which is a symmetrical key) so that the conditional access image can be safely downloaded.

The download server device 100 is included in the head end 10, and safely sends the conditional access image to the download client device 200, connected over the IP network, in compliance with the download protocol. Here, the download server device 100 sends the conditional access image to the download client device 200 in compliance with the download protocol using the communication message encrypted using the DLK (i.e., the SSL-based symmetrical key) so that the conditional access image can be safely downloaded. For this purpose, as shown in FIG. 3, the download server device 100 includes a download management module 120, an encryption module 140, and a management module 160.

The download management module 120 includes a secure channel management unit 122 and a communication message handler 124, and manages communication with the download client device 200 of the receiver 20 (i.e., a user receiver) in compliance with the SSL-based protocol over the IP network. That is, the download management module 120 receives communication messages (e.g., a communication connection request message, a download request message, and a download reception result message) for downloading the conditional access image from the download client device 200.

The download management module 120 sends the received communication messages to the management module 160. The download management module 120 sends the conditional access image, received from the management module 160, to the download client device 200 in response to the communication messages received from the download client device 200. Here, the download management module 120 receives the conditional access image, encrypted by the encryption module 140, from the management module 160.

The download management module 120 manages communication with the authentication server 300 in order to receive the DLK for encrypting the conditional access image from the authentication server 300. That is, the download management module 120 receives the DLK, used to encrypt the conditional access image sent to the download client device 200, from the authentication server 300, and sends the received DLK to the encryption module 140.

When a communication connection request message (i.e., the message “DL_HELLO” of HG. 4) including a receiver ID is received from the download client device 200 of the receiver 20, the download management module 120 receives a DLK for encrypting communication messages, exchanged between the download server device 100 and the receiver 20, from the authentication server 300. The download management module 120 sends the received DLK to the encryption module 140 so that communication messages to be sent to the download client device 200 after the communication connection request message can be encrypted using the DLK.

When a download request message (i.e., the message “DL_DOWN_REQ” of FIG. 4) is received from the download client device 200, the download management module 120 verifies the download request message. If the result of the verification is successful, the download management module 120 requests the management module 160 to send a conditional access image, and receives the conditional access image from the management module 160. The download management module 120 sends the received conditional access image and the system ID and version number of the received conditional access image to the corresponding download client device 200 using a conditional access image download message DL_CAI_DOWN. Here, the download management module 120 receives the download request message DL_DOWN_REQ, including the system ID and version number of the conditional access image which is now possessed by the receiver 20 to which the download client device 200 belongs. The download management module 120 may also receive the download request message, including the system ID and version number of the conditional access image and a receiver ID. Here, whether the system ID and the version number included in the download request message are to then be installed in the receiver 20 or are to be updated in the future may be changed depending on image management policies.

The download management module 120 receives a download reception result message (i.e., a message “DL_NOTI_DOWN_RESULT” of FIG. 4) from the download client device 200. That is, the download management module 120 receives the download reception result message, including information about the success or failure of the download related to the sent conditional access image, from the download client device 200.

The encryption module 140 encrypts a conditional access image using a DLK. That is, the encryption module 140 encrypts the conditional access image using the DLK received from the download management module 120.

The encryption module 140 encrypts a communication message used for communication with the download client device 200 using the DLK. That is, the encryption module 140 encrypts the communication message (that is, the conditional access image download message), which will be sent to the download client device 200 after the communication connection request message has been received from the download client device 200, using the DLK.

The management module 160 manages the conditional access image. That is, the management module 160 adds or deletes the conditional access image to or from a database 180. The management module 160 detects the conditional access image from the database 180 in response to the request of the download management module 120, and requests the encryption module 140 to encrypt the detected conditional access image by sending the detected conditional access image to the encryption module 140. The management module 160 receives the encrypted conditional access image from the encryption module 140, and sends it to the download management module 120. Here, the management module 160 may request the encryption module 140 to encrypt the conditional access image when the conditional access image is added, and may store, and manage the encrypted conditional access image in the database 180.

The download client device 200 downloads the conditional access image from the download server device 100, splits, encrypts, and stores the downloaded conditional access image in order to prevent the conditional access image from being copied, and restores the stored conditional access image to its original form when the conditional access image is required. For this purpose, the download client device 200 includes a download management module 220, an encryption module 240, and a splitting/restoration management module 260, as shown in FIG. 5.

The download management module 220 includes a communication channel management unit 222 and a communication message handler 224, and safely downloads a conditional access image over the IP network in compliance with a download protocol symmetrically with the download management module 220 of the download server device 100. That is, the download management module 220 establishes an SSL connection before sending and receiving communication messages, and then executes a DLK-based secure download protocol (i.e., a symmetrical key) received from a certification module.

The download management module 220 requests a communication connection for downloading the conditional access image from the download server device 100 by sending a communication connection request message (i.e., the message “DL_HELLO” of FIG. 4), including a receiver ID, to the download server device 100. The download management module 220 downloads the DLK for encrypting communication messages, exchanged between the download server device 100 and the download client device 200, and a conditional access image from the authentication client 400 by transmitting the communication connection request message. Thereafter, the download management module 220 encrypts communication messages, which will be sent to the download server device 100, using the DLK, and attaches data for verifying a signature to the communication messages.

The download management module 220 requests the download server device 100 to allow a conditional access image to be downloaded by sending the download request message (i.e., the message “DL_DOWN_REQ” of FIG. 4), including a system ID and a version number of the conditional access image which is now possessed by the receiver 20, to the download server device 100. Here, the download management module 220 may also request the download server device 100 to allow the conditional access image to be downloaded by sending the download request message, including a system ID and version number of the conditional access image and a receiver ID. Whether the system ID and the version number included in the download request message is to then be installed in the receiver 20 or is to be updated may be changed depending on image management policies.

The download management module 220 receives the conditional access image download message (i.e., the message “DL_CAI_DOWN” of FIG. 4), including the conditional access image and the system ID and version number of the conditional access image, from the download server device 100.

The download management module 220 verifies the conditional access image included in the received conditional access image download message, and sends a download reception result message (i.e., a message indicating a download success or failure) to the download server device 100.

Here, the communication messages, such as the download request message and the download reception result message, which are transmitted from the download management module 220 to the download server device 100 are messages which have been encrypted by the encryption module 240.

The encryption module 240 encrypts the communication messages, which are used for communication with the download server device 100, using the DLK. That is, when SSL-based communication with the download server device 100 is established, the encryption module 240 encrypts communication messages (e.g., a download request message and a download reception result message), which will be sent to the download server device 100, using the DLK.

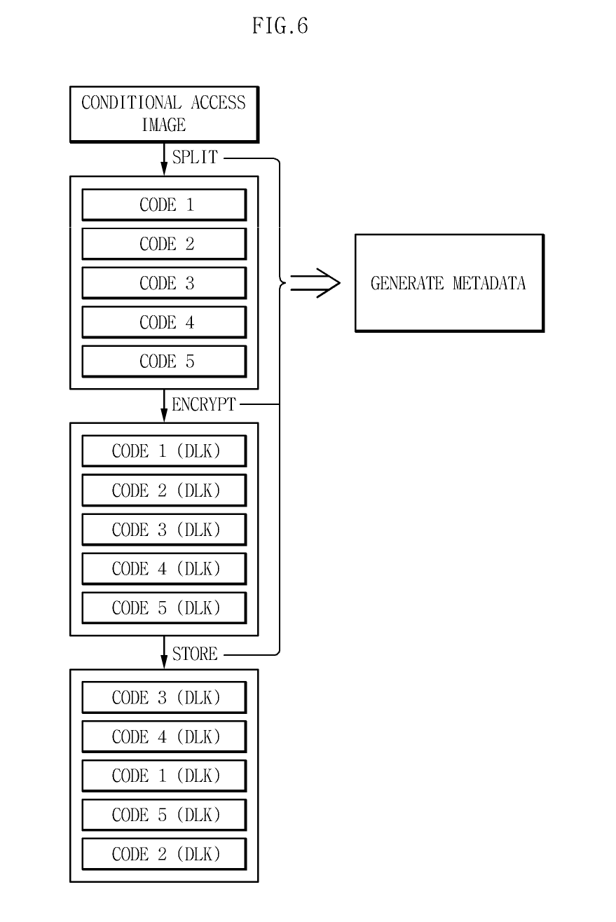

The splitting/restoration management module 260 splits, encrypts, and stores the conditional access image, downloaded from the download management module 220 to the download server device 100, in order to prevent the conditional access image from being copied. That is, as shown in FIG. 6, the splitting/restoration management module 260 splits the conditional access image into n files, encrypts the n files, and stores the n encrypted files. Here, the splitting/restoration management module 260 increases or decreases the number of times that the conditional access image is split (a split count) according to the current performance of the download client device 200 or the current level of security requirement of the download client device 200, uses different encryption keys and encryption algorithms for respective split files, and splits and encrypts the conditional access image using a variety of splitting and encryption methods, such as a method of storing the plurality of encrypted files in various locations.

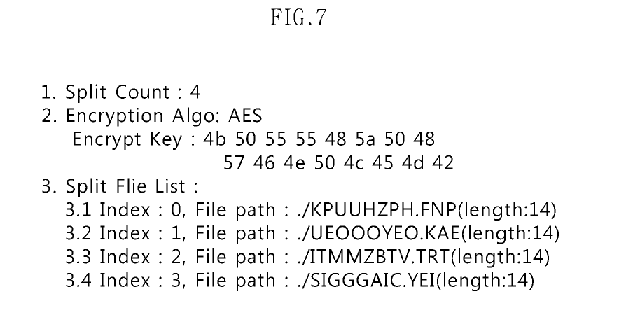

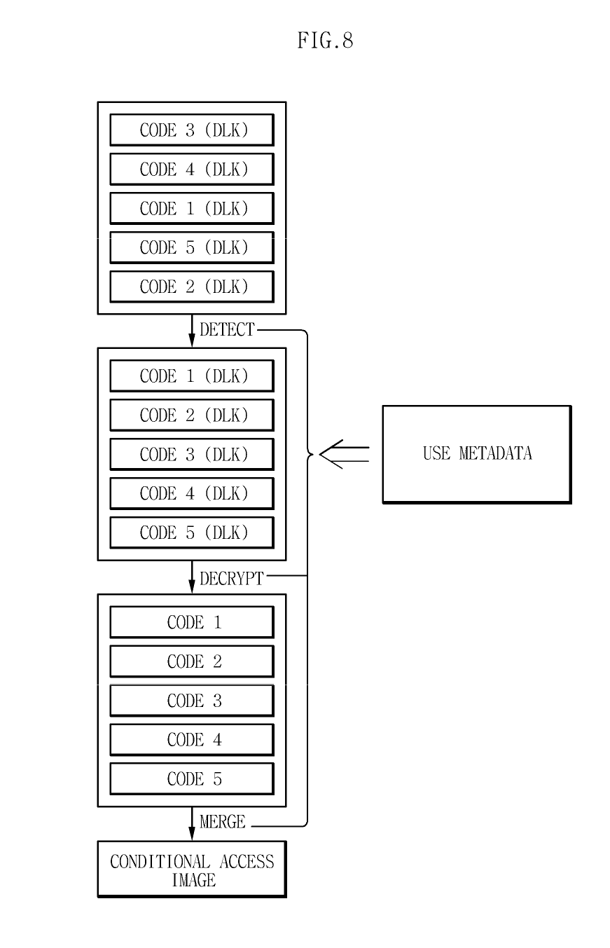

The splitting/restoration management module 260 generates and stores encryption metadata (i.e., a file storing a method of splitting and encrypting the conditional access image) during the process of splitting and encrypting the conditional access image in order to restore the split files to the original conditional access image. Here, the encryption metadata is encrypted using a DLK or a secure encryption key included in the download client device 200 for the purpose of security. Furthermore, as shown in FIG. 7, the splitting/restoration management module 260 generates and stores encryption metadata, including the number of times that the conditional access image is split (i.e., a split count), an encryption algorithm (i.e., Encryption Algo) and an encryption key (i.e., an encrypt key) for encrypting the split files, and information about the encrypted files stored as individual files (i.e., a split file list). Since the conditional access image is split and encrypted as described above, the apparatus for downloading conditional access images can prevent the conditional access image from being leaked by a disk copying method.

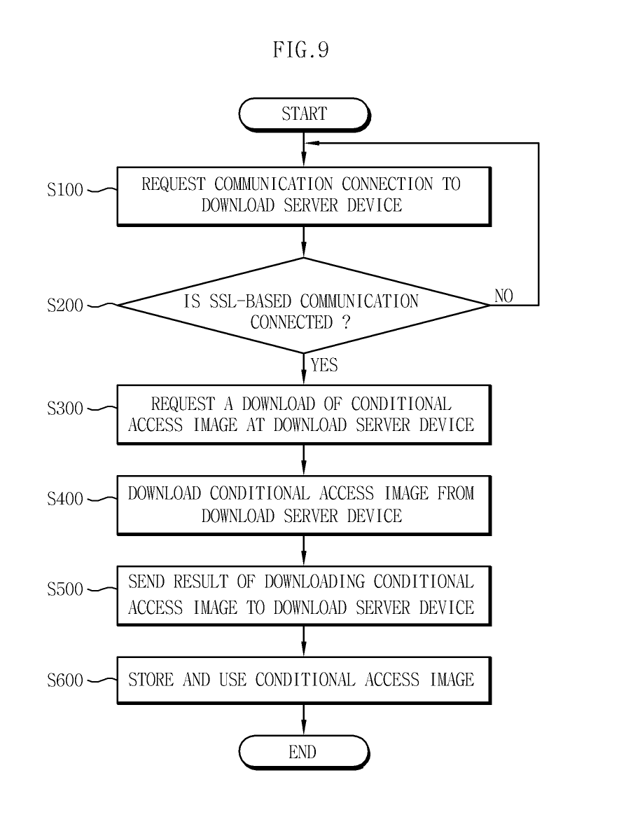

The splitting/restoration management module 260 restores the split, encrypted, and stored files to the original conditional access image. That is, as shown in FIG. 8, the splitting/restoration management module 260 restores the split and encrypted files to the original conditional access image using the encryption metadata when the conditional access image is required to use content. Here, the splitting/restoration management module 260 deletes the restored conditional access image to realize safety. At this time, the split and encrypted files have already been stored in the splitting/restoration management module 260. That is, when the conditional access image is required, the splitting/restoration management module 260 may repeatedly restore the split and encrypted files (i.e., the split files of the conditional access image) to the original conditional access image using the encryption metadata, and use the restored conditional access image.

In order to perform the above-described operation, the splitting/restoration management module 260 includes a conditional access image splitting unit 262 for splitting, encrypting, and storing the downloaded conditional access image in order to prevent the conditional access image from being copied and a conditional access image restoration unit 264 for restoring the split and encrypted files to the original conditional access image using the encryption metadata when the image is required.

The conditional access image splitting unit 262 splits the conditional access image, received via the download management module 220, into a plurality of files, encrypts the plurality of split files, and stores the plurality of encrypted files. In this process, the conditional access image splitting unit 262 generates encryption metadata when the conditional access image is split and encrypted. The encryption metadata generated by the conditional access image splitting unit 262 is encrypted and stored using a DLK. The encryption metadata includes the split count of the conditional access image, an encryption algorithm or key for encrypting the plurality of split files, and storage information about the plurality of encrypted files.

The conditional access image restoration unit 264 restores the plurality of encrypted files to the original conditional access image when the conditional access image is required. The conditional access image restoration unit 264 restores the plurality of encrypted files to the original conditional access image by decrypting and merging the encrypted files using the encryption metadata which is generated when the conditional access image is split and encrypted. The conditional access image restoration unit 264 deletes the restored conditional access image after the restored conditional access image has been used.

Hereinafter, a method of downloading conditional access images according to an embodiment of the present invention is described in detail with reference to the accompanying drawings.

FIG. 9 is a flowchart illustrating a method of downloading conditional access images according to the embodiment of the present invention.

The download client device 200 requests a communication connection from the download server device 100 at step S100. That is, the download management module 220 of the download client device 200 requests a communication connection for downloading conditional access images by sending a communication connection request message, including a receiver ID, to the download management module 120 of the download server device 100. In response to the request, the download management module 120 of the download server device 100 establishes an SSL-based communication connection with the download client device 200. In order to encrypt communication messages exchanged between the download server device 100 and the download client device 200, the download management module 120 of the download server device 100 receives a DKL from the authentication server 300, and the download client device 200 receives a DLK from the authentication client 400. The download management modules 120 and 220 of the download server device 100 and the download client device 200 encrypt the communication messages, sent after the communication connection was established, using the DLK, attaches data for verifying a signature to the communication messages, and send the communication messages.

When the SSL-based communication connection with the download server device 100 has been established (YES at step S200), the download client device 200 requests the download server device 100 to allow the conditional access image to be downloaded at step S300. That is, the download management module 220 of the download client device 200 requests the download server device 100 to allow the conditional access image to be downloaded by sending a download request message, including a system ID and version number of the conditional access image now possessed by the receiver 20, to the download server device 100. Here, the download management module 220 of the download client device 200 may also request the download of the conditional access image by sending the download request message, including the system ID and version number of the conditional access image and a receiver ID, to the download server device 100. Furthermore, whether the system ID and version number included in the download request message is to then be installed in the receiver 20 or is to be updated may be changed according to image management policies. Thereafter, the download management module 120 of the download server device 100 verifies the download request message. If the result of the verification is successful, the download management module 120 requests the conditional access image from the management module 160 and receives the conditional access image therefrom. The download management module 120 of the download server device 100 sends the received conditional access image and the system ID and version number of the conditional access image to the corresponding download client device 200 using a conditional access image download message.

The download client device 200 downloads the conditional access image from the download server device 100 at step S400. That is, the download management module 220 of the download client device 200 receives the conditional access image download message, including the conditional access image and the system ID and version number of the corresponding conditional access image, from the download server device 100.

The download client device 200 sends the results of downloading the conditional access image to the download server device 100 at step S500. That is, the download management module 220 of the download client device 200 verifies the conditional access image included in the received conditional access image download message, and sends a download reception result message (i.e., a message indicating a download success or failure) to the download server device 100.

The download client device 200 uses the received conditional access image at step S600. That is, the download client device 200 splits, encrypts, and stores the downloaded conditional access image in order to prevent the conditional access image from being copied, and restores the stored conditional access image to its original form when the conditional access image is required.

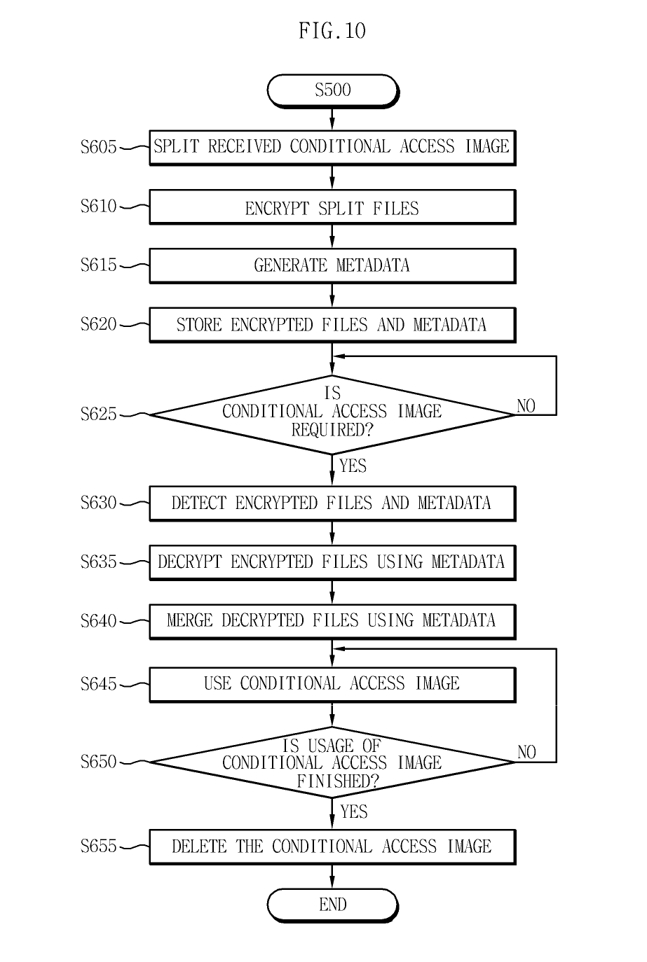

FIG. 10 is a flowchart illustrating the steps of storing and using a conditional access image, which are shown in FIG. 9.

The download client device 200 splits, compresses, and stores the conditional access image received from the download server device 100 in order to safely store the received conditional access image. For this purpose, the download client device 200 splits the received conditional access image at step S605. That is, the splitting/restoration management module 260 of the download client device 200 splits the conditional access image into n files. Here, the splitting/restoration management module 260 may increase or decrease the number of times that the conditional access image is split according to the current performance of the download client device 200 or the current level of security requirement.

The download client device 200 encrypts the n split files at step S610. That is, the splitting/restoration management module 260 of the download client device 200 encrypts the n split files. Here, the splitting/restoration management module 260 may encrypt the respective n split files using different encryption keys or passwords and different encryption algorithms.

Thereafter, the download client device 200 generates encryption metadata, including the method of splitting and encrypting the conditional access image at step S615. That is, the splitting/restoration management module 260 of the download client device 200 generates the encryption metadata (i.e., a file storing the method of splitting and encrypting the conditional access image) in the process of splitting and encryption the conditional access image in order to restore the conditional access image.

The download client device 200 stores the split and encrypted files and the generated encryption metadata at step S620. Here, the splitting/restoration management module 260 of the download client device 200 stores the plurality of encrypted files in various locations. That is, the splitting/restoration management module 260 of the download client device 200 stores the plurality of encrypted files in the database 180 (e.g., the hard disk of a receiver) in the order of splitting, or randomly changes the order of splitting and stores the plurality of encrypted files in the database 180. The splitting/restoration management module 260 of the download client device 200 encrypts the encryption metadata using a DLK or a secure encryption key included in the download client device 200 in order to realize security, and stores the encrypted metadata in the database 180 (e.g., the hard disk of a receiver). Since the conditional access image is split, encrypted, and stored as described above, the apparatus for downloading conditional access images can prevent the conditional access image from being leaked using a disk copying method.

When the time at which the conditional access image is necessary is reached (YES at step S625), the download client device 200 detects the stored files and the encryption metadata at step S630. That is, when the conditional access image is required to use content, the splitting/restoration management module 260 detects the encryption metadata encrypted and stored in the database 180. The splitting/restoration management module 260 decrypts the detected encryption metadata using a DLK or an encryption key.

The download client device 200 decrypts the detected files using the encryption metadata at step S635, merges the decrypted files into the conditional access image of an original state, received from the download server device 100, using the encryption metadata at step S640, and uses the restored conditional access image at step S645.

After the use of the conditional access image has been completed (YES at step S650), the download client device 200 deletes the used conditional access image at step S655. That is, the splitting/restoration management module 260 deletes the restored and used conditional access image in its original form in order to prevent the conditional access image from being copied. Here, the split and encrypted files have been stored in the database 180. Accordingly, the splitting/restoration management module 260 can repeatedly restore the split and encrypted files (i.e., the split files of the conditional access image) to the original conditional access image using the encryption metadata and use the restored conditional access image.

As described above, the apparatus and method for downloading conditional access images are configured to download a conditional access image using a download message, encrypted using a symmetrical key, over an SSL-based secure channel, to split, encrypt, and store the downloaded conditional access image, to restore the split files to the original conditional access image when the conditional access image is required, and to delete the restored conditional access image after it has been used. Accordingly, there is the advantage of preventing a conditional access image, which may be used when a hard disk is copied, from leaking, thereby enhancing the security of a software-based CAS.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A software-based conditional access image download client device, comprising:
a download management module for establishing a secure channel for communicating with a download server device over a network, and communicating with the download server device in compliance with a download protocol;
a conditional access image splitter for splitting a conditional access image, received via the download management module, into a plurality of files, generating a plurality of encrypted files by encrypting the plurality of files, and storing the plurality of encrypted files; and
a conditional access image restoration unit for restoring the plurality of encrypted files to the conditional access image when the conditional access image is required.

2. The software-based conditional access image download client device of claim 1, further comprising an encryption module for encrypting communication messages using a download key, the encrypting communication message being used for communicating with the download server device.

3. The software-based conditional access image download client device of claim 1, wherein the conditional access image splitter generates encryption metadata when the conditional access image is split and encrypted.

4. The software-based conditional access image download client device of claim 3, wherein the encryption metadata includes the number of times that the conditional access image is split, encryption algorithms and encryption keys for the split files, and information about storage of the encrypted files.

5. The software-based conditional access image download client device of claim 3, wherein the encryption metadata generated by the conditional access image splitter is encrypted and stored using a download key.

6. The software-based conditional access image download client device of claim 1, wherein the conditional access image restoration unit restores the conditional access image by decrypting and merging the plurality of encrypted files using encryption metadata which is generated when the conditional access image is split and encrypted.

7. The software-based conditional access image download client device of claim 1, wherein the conditional access image restoration unit deletes the restored conditional access image when usage of the restored conditional access image is finished.

8. A software-based conditional access image download server device, comprising:
a download management module for establishing a secure channel for communicating with a download client device over a network, and communicating with the download client device in compliance with a download protocol;
a conditional access image management module for generating a conditional access image using a key management module necessary to acquire a control word; and
an encryption module for generating an encrypted communication message by encrypting a communication message using a download key, the communication message will be sent to the download client device in compliance with the download protocol and includes the conditional access image.

9. The software-based conditional access image download server device of claim 8, wherein the network is an IP-based network.

10. The software-based conditional access image download server device of claim 8, wherein the conditional access image is split and managed by the download client device.

11. The software-based conditional access image download server device of claim 8, wherein the download management module executes a Secure Socket Layer (SSL)-based download protocol along with the download client device.

12. A software-based conditional access image download method, comprising:
establishing a secure communication channel with a download server device over a network and communicating with the download server device in compliance with a download protocol;
splitting a conditional access image, downloaded from the download server device, into a plurality of files, generating a plurality of encrypted files by encrypting the plurality of split files, and storing the plurality of encrypted files; and
restoring the conditional access image from the plurality of encrypted files.

13. The software-based conditional access image download method of claim 12, wherein the communicating with the download server device comprises executing an SSL-based download protocol over an IP-based network.

14. The software-based conditional access image download method of claim 12, wherein the conditional access image is generated using a key management module for acquiring a control word.

15. The software-based conditional access image download method of claim 12, wherein the communicating with the download server device comprises encrypting a communication message, used when communicating with the download server device in order to download the conditional access image, using a download key and sending the encrypted communication message.

16. The software-based conditional access image download method of claim 12, wherein the storing the plurality of encrypted files comprises encrypting each of the plurality of files using a download key.

17. The software-based conditional access image download method of claim 12, further comprising deleting the restored conditional access image after using the restored conditional access image.

18. The software-based conditional access image download method of claim 12, further comprising generating encryption metadata, including a number of times that the conditional access image is divided, encryption algorithms and encryption keys for the split files, and information about storage of the plurality of encrypted files based on the merging and encryption of the conditional access image.

19. The software-based conditional access image download method of claim 18, wherein the encryption metadata is encrypted and stored using one of a download key and an encryption key.

20. The software-based conditional access image download method of claim 12, wherein the restoring the conditional access image comprises restoring the plurality of encrypted files to the conditional access image by decrypting the plurality of encrypted files using encryption metadata generated when the plurality of encrypted files are stored and merging the decrypted files into the conditional access image.
